(19) United States
(12) Patent Application Publication
(10) Pub. No.: US 2011/0133667 A1
(43) Pub. Date: Jun. 9, 2011

(54) CONTROL BOX FOR A CHRISTMAS LIGHT STRING

(76) Inventor: Chen-Sheng YANG, Kaohsiung (TW)

(21) Appl. No.: 12/633,818

(22) Filed: Dec. 9, 2009

(51) Int. Cl. H05B 41/36

(52) U.S. Cl. 315/294

(57) ABSTRACT

A control box for a Christmas light string is connected between a plug and a light string. The control box has a harmonic reducing element, an AC/DC converting circuit, a driving circuit and multiple switches. The AC/DC converting circuit converts AC power to DC power. The driving circuit outputs controls signals to turn on or off the switches, whereby light units of the light string are correspondingly activated or deactivated by the switches. The harmonic reducing element is connected between the plug and the AC/DC converting circuit to reduce or eliminate harmonics resulted from the operations of the switches. Therefore, the AC power input to the control box is prevented form being interfered by the harmonics to ensure the light string operates normally.

### BACKGROUND OF THE INVENTION

1. Field of the Invention

The invention relates to a control box for a Christmas light string, and more particularly to a control box integrated with a capacitor to reduce noises and harmonics resulted from other components in the control box.

2. Description of Related Art

With reference to FIG. 3, a convention control device (50) is connected to a light string such as an LED light string, Christmas light string etc. composed of multiple light units (60). The control device (50) comprises a plug (52) and a control box (54). The plug (52) is connected to an AC power source. The control box (54) may comprise an AC/DC converting circuit (541), a driving circuit (542) and multiple silicon-controlled rectifiers (SCRs) (543) as switches for the light units (60) respectively. The AC/DC converting circuit (541) receives and converts the AC power to DC power for activating the light string. The driving circuit (542) turns on or off the SCRs (543) so that the corresponding light units (60) can be activated or deactivated.

However, as the SCRs (543) turn on and off, the AC power applied to the control device (50) are affected by harmonics resulted from the SCRs (543) and becomes unstable. The light units (60) are interfered by the unstable power and operated incorrectly.

To overcome the shortcomings, the present invention provides a control box for a Christmas light string to mitigate or obviate the aforementioned problems.

### SUMMARY OF THE INVENTION

The main objective of the present invention is to provide a control box integrated with a capacitor to eliminate noises and harmonics interference resulted from other electric components in the control box.

The control box in accordance with the present invention comprises an AC/DC converting circuit, a driving circuit, multiple switches and a harmonic reducing element. The AC/DC converting circuit receives and converts AC power to DC power. The driving circuit is connected to the AC/DC converting circuit to receive the DC power and outputs control signals. The multiple switches are connected to the driving circuit and receive the control signals to control the Christmas light string based on the control signals. The harmonic reducing element, such as a capacitor, is connected between the AC/DC converting circuit and the plug to reduce harmonics resulted from the switches.

Therefore, the harmonic caused from the switches will be mitigated or eliminated by the harmonic reducing element. The AC power input to the control will not interfered by the harmonic to ensure that the light string operates normally.

Other objectives, advantages and novel features of the invention will become more apparent from the following detailed description when taken in conjunction with the accompanying drawings.

### BRIEF DESCRIPTION OF THE DRAWINGS

FIG. 1 is a control circuit diagram of a control box for a Christmas light string in accordance with the present invention;

FIG. 2 is a perspective view of the control box in accordance with the present invention connected to a plug; and

FIG. 3 is a control circuit diagram of a conventional light control device.

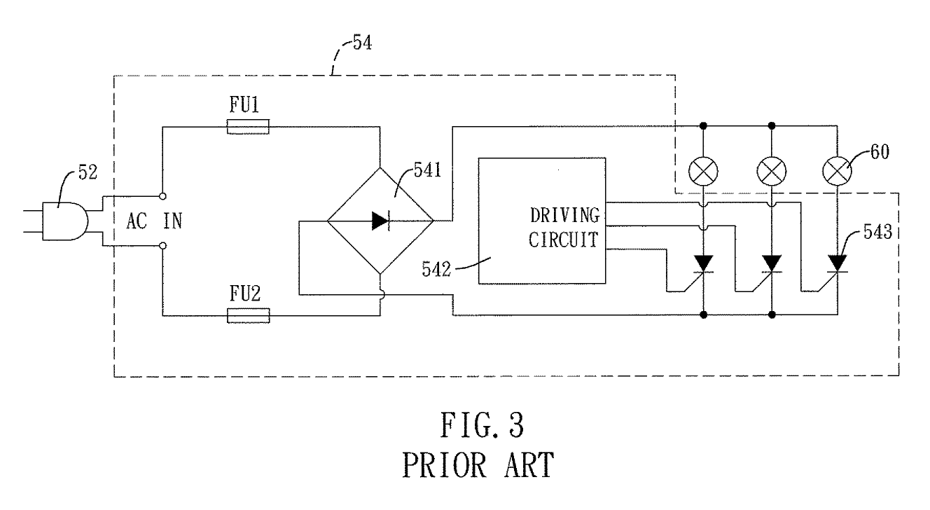

### DETAILED DESCRIPTION OF THE PREFERRED EMBODIMENT

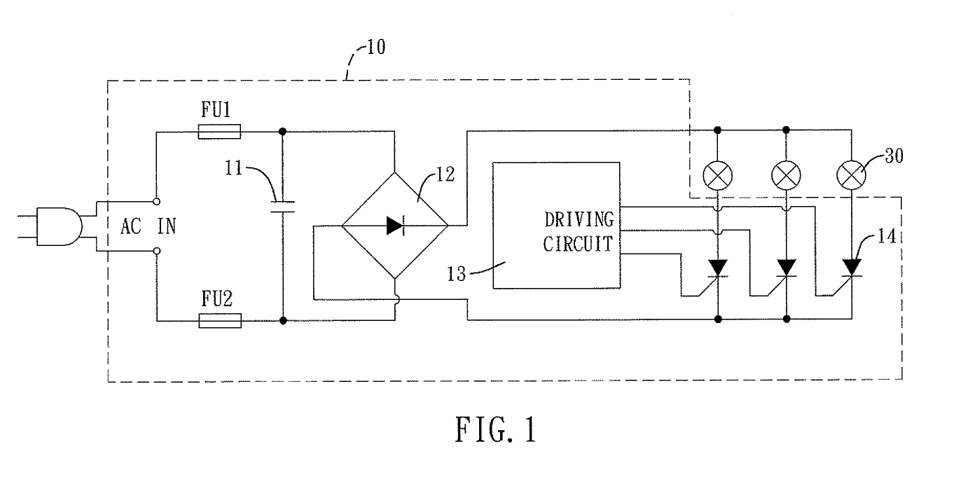

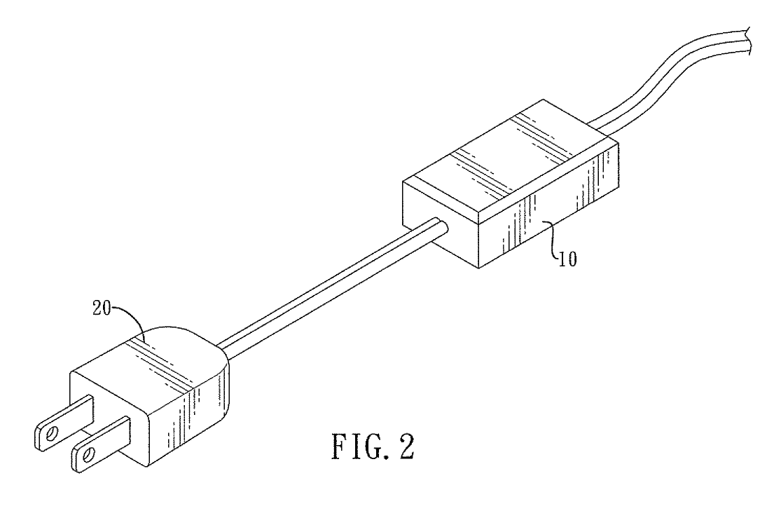

With reference to FIGS. 1 and 2, a control box (10) for a Christmas light string in accordance with the present invention receives AC power through a plug (20) and controls a light string composed of multiple light units (30).

The control box (10) comprises a harmonic reducing element (11), an AC/DC converting circuit (12), a driving circuit (13) and multiple switches (14).

The harmonic reducing element (11) may be a capacitor and is connected between the plug (20) and the AC/DC converting circuit (12). The AC power from the plug (20) passes through the harmonic reducing element (11) to the AC/DC converting.

The AC/DC converting circuit (12) may be a full-bridge converter and receives and converts the AC power to DC power.

The driving circuit (13) may be an integrated circuit (IC) and outputs control signals and receives the DC power.

The switches (14) may be silicon-controlled rectifiers (SCR) and are connected to the driving circuit (13) to receive the control signals. The switches (14) are respectively connected to the light units (30). When the switch (14) is turned on by the control signal, the corresponding light unit (30) is activated.

The harmonic caused from the switches (14) will be reduced or eliminated by the harmonic reducing element (11). Therefore, the AC power inputted to the control box (10) remains stable and the light string is prevented from operating incorrectly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A control box for a Christmas light string, the control box adapted to receive an AC power from a plug and comprising:
an AC/DC converting circuit receiving and converting the AC power to DC power;
a driving circuit connected to AC/DC converting circuit, receiving the DC power and outputting control signals;
multiple switches connected to the driving circuit and receiving the control signals to control the Christmas light string based on the control signals;
a harmonic reducing element connected between the AC/DC converting circuit and the plug and reducing harmonics resulted from the switches.

2. The control box as claimed in claim 1, wherein the harmonic reducing element is a capacitor.

3. The control box as claimed in claim 1, wherein the switches are silicon-controlled rectifiers.
